(19) United States
(12) Patent Application Publication
(10) Pub. No.: US 2006/0017234 A1
(43) Pub. Date: Jan. 26, 2006

(54) Interface joint structure and a ring used therein

(75) Inventors: Wen-Chin Kuo, Taoyuan (TW); Hong-Cheng Sheu, Taoyuan (TW)

Correspondence Address: WELSH & KATZ, LTD, 120 S RIVERSIDE PLAZA, 22ND FLOOR, CHICAGO, IL, 60606, US

(73) Assignee: Delta Electronics, Inc., Taoyuan (TW)

(21) Appl. No.: 10/943,614

(22) Filed: Sep. 17, 2004

(30) Foreign Application Priority Data
Jul. 23, 2004 (TW) 93211719

(51) Int. Cl. F16J 15/02

(52) U.S. Cl. 277/630

(57) ABSTRACT

A improved interface joint structure applied as a buffer between a device and an equipment when the device is assembled to the equipment, comprises: a ring used between the device and the equipment having a first surface contacting the equipment and a second surface contacting the device, and a first ring rib located at the peripheral of the first surface; and a second ring rib located at the peripheral of the device that contacts the second surface. When the device and the equipment are screwed together, the improved interface joint structure is formed through compression of the first ring rib on the equipment and compression of the second ring rib on the second surface of the ring.

### BACKGROUND OF THE INVENTION

1. Field of Invention

The invention relates to an interface joint structure and, in particular, to an improved interface joint structure and a ring used therein.

2. Related Art

To prevent direct contact friction between devices (e.g. when embedding a control panel into a machine) and to avoid the intrusion of moisture and dust through the contact surface, there is usually an interface joint structure at the contact interface as a buffer between the device and the machine. For example, FIGS. 1A and 1B show a conventional device. A control panel 1 is embedded into a machine 3. In order to avoid direct contact and the intrusion of moisture through the contact surface, a ring 5 is used as an interface joint structure and a buffer. Its tight connections with the control panel 1 and the machine 3 prevent the moisture from entering.

As shown in FIG. 1A, one has to make sure that one surface of the ring 5 and the control panel 1 of the machine 3 are tightly combined during the assembly. Afterwards, as shown in FIG. 1B, the other surface of the ring 5 also has to touch tightly with the machine after the control panel 1 is embedded into the machine 3.

Since the contact between the ring and the machine or control panel is surface to surface, it is quite likely that the contact surface may be uneven due to an inhomogeneously imposed force. Moreover, the conventional ring has a flat structure. Its deformation requires a larger force. Therefore, with a limited number of fixtures, the ring may not be able to stick tightly. Thus, we see that using the conventional ring as the interface joint structure between a control panel and a machine requires one to carefully check and assemble the parts in order to avoid the intrusion of moisture.

Consequently, how to provide a new interface joint structure that is easier to be deformed as a buffer between a device and a machine and to avoid the intrusion of moisture and dusts is an important issue in the field.

### SUMMARY OF THE INVENTION

In view of the foregoing, an objective of the invention is to provide an improved interface joint structure and a ring thereof, so that a machine and its embedded device can be attached to each other tightly. The invention functions as a buffer and to avoid the intrusion of moisture and dusts.

Another objective of the invention is to provide an improved interface joint structure and a ring thereof, so that the connection between the device and the machine will not be affected by the inhomogeneous force imposed thereon.

Yet another objective of the invention is to provide an improved interface joint structure and a ring thereof, so that the ring and the device and/or the ring and the machine can be tightly naturally connected under a pressure without making sure that the ring is in a flat contact or checking whether the ring surface is even.

To achieve the above objective, the disclosed improved interface joint structure is inserted between a machine and an inserted device as a buffer. The disclosed improved interface joint structure contains: a ring, which is inserted between the device and the machine and has a first interface in contact with the machine and a second surface in contact with the device; a first ring rib located at the peripheral of the first surface; and a second ring rib located at the peripheral of the device to be in contact with the second surface. When the device and the machine are connected tightly, the first ring rib is pressed against the machine while the second ring rib is deeply trapped on the second surface of the ring, forming the interface joint structure.

To achieve the above objective, the disclosed ring has a first surface in contact with the machine and a second surface in contact with the device. When the device is inserted into a machine, the disclosed ring will function as a buffer in between. The ring has a first ring rib located at the peripheral of the first surface.

To achieve the above objective, the disclosed ring has a first surface and a second surface. When a device is inserted into a machine, the disclosed ring will function as a buffer in between. When the device and the machine are connected tightly, the first surface of the ring is tightly connected to the machine under a pressure. The second surface of the ring is tightly connected to the device under a pressure. The ring also has a first ring rib located at the peripheral of the first surface and a second ring rib located at the peripheral of the second surface.

The rings described above are made of rubber.

### BRIEF DESCRIPTION OF THE DRAWINGS

The invention will become more fully understood from the detailed description given hereinbelow illustration only, and thus are not limitative of the present invention, and wherein:

FIGS. 1A and 1B show the assembly flowchart of inserting a control panel into a machine in a conventional device;

FIGS. 2A and 2B show the assembly flowchart of inserting a control panel into a machine using the invention;

FIG. 3A is a cross-sectional view of the disclosed interface joint structure; and

FIG. 3B is another embodiment of the ring in the disclosed interface joint structure.

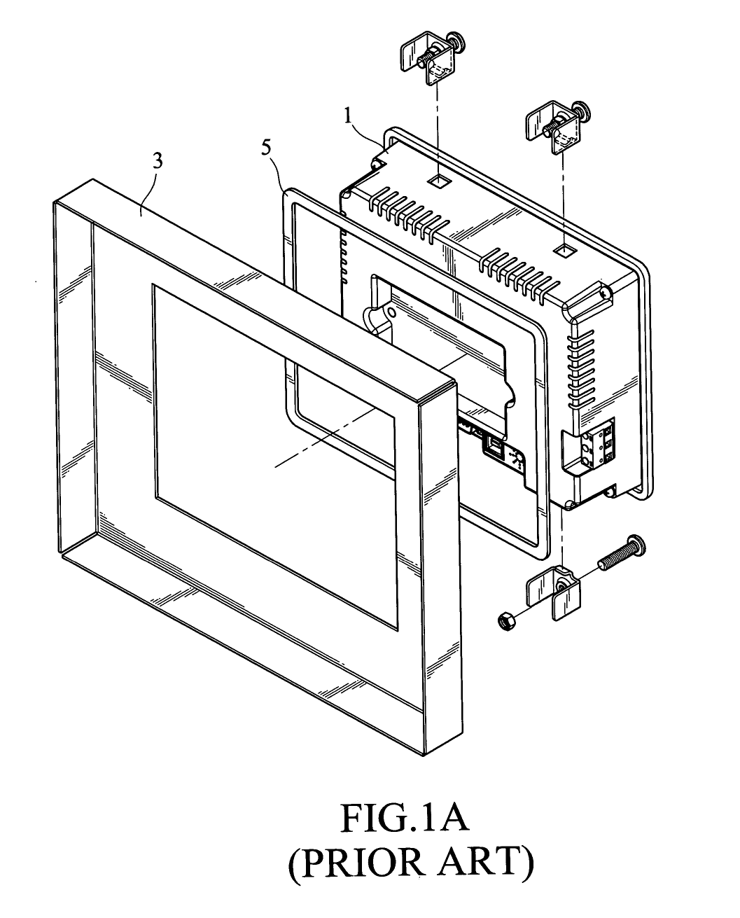

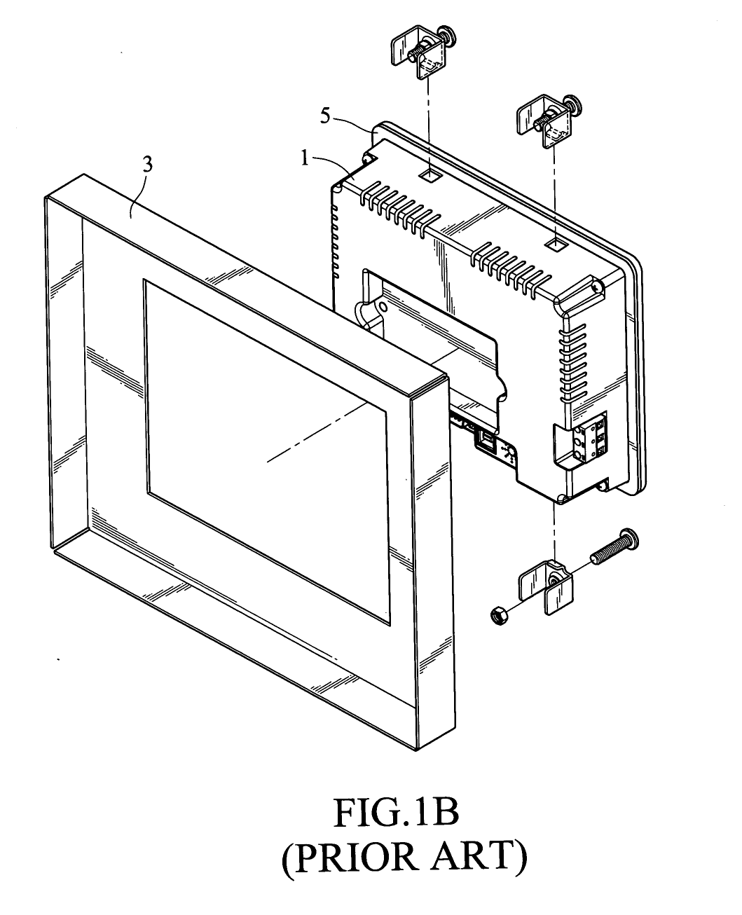

### DETAILED DESCRIPTION OF THE INVENTION

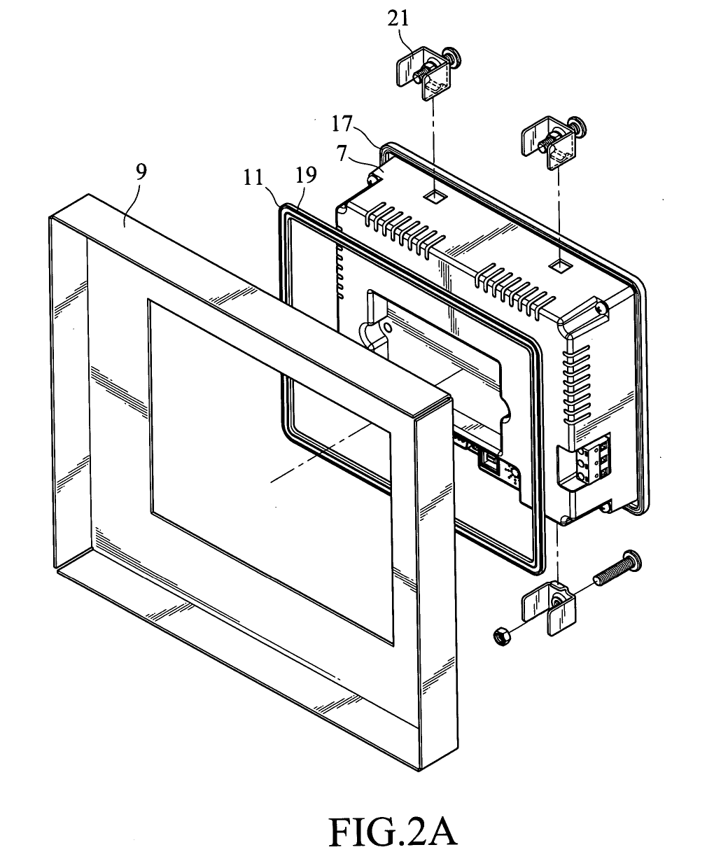

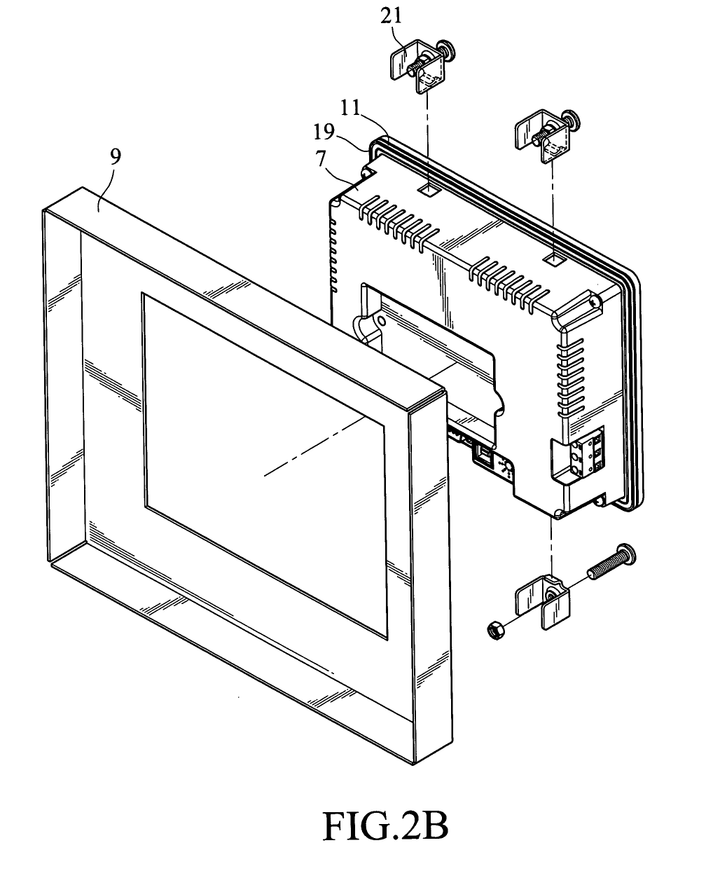

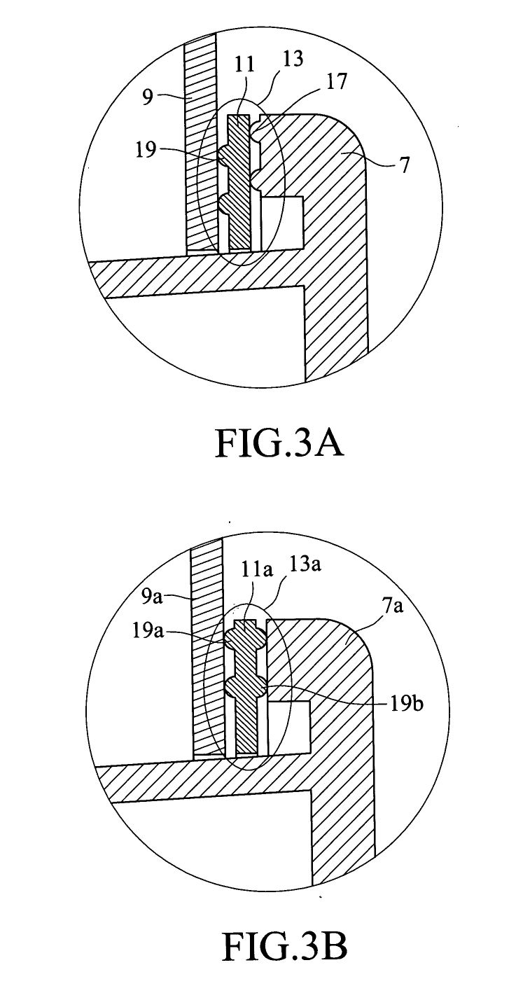

FIGS. 2A to 3A shows a flowchart of inserting a control panel into a machine according to the invention. In order that there is no direct friction between the control panel 7 and the machine 9 or no moisture enters through the contact surface between them, an interface joint structure 13 (in FIG. 3A) is usually used on the contact surface.

The invention is featured in the interface joint structure 13 between the control panel 7 and the machine 9. The interface joint structure 13 contains: a ring 11 inserted between the control panel 7 and the machine 9, and at least a second ring rib 17 located at the peripheral of the control panel 7 to be in contact with the second surface of the ring 11. The first surface of the ring 11 has at least a first ring rib 19, crossing the second ring rib 17 surrounding the control panel 7.

When the ring 11 is installed on the device, the second ring rib 17 of the device is deeply trapped on the first surface of the ring 11. When the control panel 7 is brought to contact the machine via the ring 11 and a fixture 21 is used to impose a pressure, the first ring rib 19 on the ring 11 is pressed and deformed. Therefore, the ring 11 and the machine 9 can be attached together tightly. Thus, the disclosed interface joint structure 13 can achieve the effects of avoiding direct friction between the device and the machine and waterproof at the interface.

In other words, the interface joint structure 13 uses the second ring rib on the control panel 7 to connect with the ring 11 and the first ring rib 19 on the ring 11 to connect with the machine 9, achieving tight connection, waterproof, and dust-proof effects between the control panel 7 and the machine 9.

FIG. 3A is a cross-sectional view of the disclosed interface joint structure. The second ring rib 17 on the control panel 7 and the first ring rib 19 on the ring 11 cross to each other in order to form a tight interface joint structure 13 when the control panel 7, the ring 11, and the machine 9 are locked together.

Although the interface joint structure shown in the drawing contains only two second ring ribs and two first ring ribs that cross each other, the invention, however, is not limited by the numbers of the second and first ring ribs. They can be provided according to the practical needs.

The assembly is shown in FIGS. 2A and 2B. As shown in FIG. 2A, one first attach the surface of a product, such as a control panel 7 of a machine, that has the second ring rib 17 onto the surface of the ring 11 without a ring rib. When attached together, the protruding second ring rib 17 is deeply trapped in the ring 11, forming a tight contact. As shown in FIG. 2B, one puts the product 7 with the properly installed ring 11 into the machine 9. The surface of the ring 11 with the first ring rib 19 has to be tightly attached onto the machine 9. Likewise, the first ring rib 19 is pressed tightly on the machine 9.

In summary, the second ring rib on the device, the ring, and the first ring rib on the ring form a tight interface joint structure when the ring and the machine are attached together. It provides the buffering, waterproof, and dust-proof effects.

FIG. 3B shows anther embodiment of the ring in the interface joint structure. The first surface of the ring has a first ring rib 19a, and the second surface has a second ring rib 19b. The first ring rib 19a and the second ring rib 19b can be provided in an interleaving manner. Therefore, the interface joint structure 13a of the ring 11a is shown in FIG. 3B. The product, such as the control panel 7a of a machine, does not need a ring rib on its contact surface with the ring 11a. The ring 11a can be directly inserted between the control panel 7a and the machine 9a. When the control panel 7a is pressed against the machine 9a, the first ring rib 19a is pushed to attach on the surface of the machine 9a. The second ring rib 19b is also attached on the control panel 7a. Therefore, a tight interface joint structure is formed between the control panel 7a and the machine 9a, achieving the buffering, waterproof, and dust-proof effects in between.

The rings described above are made of elastic materials such as rubber.

In summary, the interface joint structure between a machine and its inserted device disclosed herein and the ring thereof can assure a tight connection between the ring and the device. After the device with the ring is inserted into the machine, a tight connection surface is also formed between the ring and the machine. The invention thus achieves the buffering, waterproof, and dust-proof effects between the device and the machine.

The disclosed interface joint structure between a machine and its inserted device along with the ring thereof are free from the problem of an inhomogeneously imposed force when the machine and the device are combined together.

Using disclosed interface joint structure between a machine and its inserted device along with the ring thereof, one does not need to worry about the problem of moisture leaking resulted from insecure connection between the machine and the device due to an uneven ring surface.

Certain variations would be apparent to those skilled in the art, which variations are considered within the spirit and scope of the claimed invention.

What is claimed is:

1. An interface joint structure as a buffer between a machine and a device inserted therein, the interface joint structure comprising:
a ring, which is inserted between the device and the machine and contains a first surface in contact with the machine, a second surface in contact with the device, and a first ring rib located at the peripheral of the first surface; and
a second ring rib, which is located at the peripheral of the device to be in contact with the second surface.

2. The interface joint structure of claim 1, wherein the first ring rib and the second ring rib cross each other.

3. The interface joint structure of claim 1, wherein the ring is made of rubber.

4. A ring, comprising a first surface in contact with a machine and a second surface in contact with a device, as a buffer between the device and the machine; wherein the ring further contains a first ring rib located at the peripheral of the first surface.

5. A ring, comprising a first surface and a second surface, as a buffer between a device and a machine; wherein when the device and the machine are combined together, the first surface of the ring is in tight contact with the machine under a pressure, the second surface of the ring is in tight contact with the device under a pressure, and the ring further contains:
a first ring rib, which is located at the peripheral of the first surface; and
a second ring rib, which is located at the peripheral of the second surface.

6. The ring of claim 5, wherein the first ring rib and the second ring rib cross each other.
